(19) United States
(12) Patent Application Publication
(10) Pub. No.: US 2012/0192208 A1
(43) Pub. Date: Jul. 26, 2012

(54) Method, Apparatus and Computer Program for Providing Multimedia Functions Using a Software Wrapper Component

(75) Inventor: Maria Pascual-Borrego, London (GB)

(73) Assignee: NOKIA CORPORATION, Espoo (FI)

(21) Appl. No.: 13/378,351

(22) PCT Filed: May 25, 2010
(86) PCT No.: PCT/IB10/52319

§ 371 Date: Mar. 12, 2012

(30) Foreign Application Priority Data
Jun. 29, 2009 (GB) 0911234.3

(51) Int. Cl. G06F 9/44; G06F 9/46

(52) U.S. Cl. 719/320

(57) ABSTRACT

Examples of the invention relate to a method, apparatus and computer program for performing a multimedia function in a computing device using a software wrapper component. The wrapper component comprises one or more multimedia software subcomponents. Each of the subcomponents performs at least part of the multimedia function. The wrapper component is capable in use of controlling the one or more multimedia subcomponents to perform the multimedia function in response to a request from a client component.

### TECHNICAL FIELD

Embodiments of the present invention relate generally to computing devices. More particularly, embodiments relate to a method, apparatus and computer program for providing multimedia functions in computing devices.

### BACKGROUND

The prevalence of multimedia software applications has lead to their use on an array of different computing platforms. As a result of this, a need has arisen to make multimedia applications portable across multiple different computing device platforms. The OpenMAX standard provides an API for developing software for multimedia applications which is portable across multiple different computing device platforms.

### SUMMARY OF EMBODIMENTS

Various aspects of examples of the invention are set out in the claims.

A first example of the invention provides a method, comprising performing a multimedia function in a computing device using a software wrapper component, said wrapper component comprising one or more multimedia software subcomponents each of which performs at least part of the multimedia function, said wrapper component being capable in use of controlling the one or more multimedia subcomponents to perform the multimedia function in response to a request from a client component.

In an example, said wrapper component is capable in use of inserting and/or removing into said wrapper component at least one of the one or more multimedia subcomponents while performing said multimedia function.

In an example, said multimedia function is embodied in a finite state machine and the wrapper component is capable in use of behaving according to the finite state machine to perform said multimedia function.

In an example, said wrapper component is capable in use of providing an output to the client component, said output comprising a callback from at least one of the one or more multimedia subcomponents.

In an example, said wrapper component is capable in use of providing the client component with access to control a function of at least one of the one or more multimedia subcomponents.

In an example, said wrapper component further comprises an input port and an output port for communicating with other wrapper components and the client component, said wrapper input port corresponding to an input port of one of the one or more subcomponents, said wrapper output port corresponding to an output port of one of the one or more subcomponents.

In an example, said wrapper input and output ports correspond to edge ports of the one or more multimedia subcomponents.

In an example, said wrapper component is capable in use of managing access to a limited resource of the computing device by at least one of the one or more multimedia subcomponents.

In an example, said wrapper component is capable in use of controlling the one or more multimedia subcomponents to perform said multimedia function in dependence on an availability of a limited resource of the computing device.

In an example, said wrapper component is capable in use of:

receiving from the client component an instruction to be notified if there are sufficient computing device resources available for the wrapper to control the one or more multimedia subcomponents perform said multimedia function;

identifying if sufficient computing device resources are currently available; and,

notifying the client component if sufficient computing device resources are currently available. In another example, said wrapper component determines that sufficient computing device resources are not available and the wrapper component is capable in use of notifying the client component when sufficient computing device resources become available in the future.

In an example, said wrapper component comprises a plurality of wrapper components.

In an example, at least one of the one or more multimedia subcomponents is a wrapper component.

In an example, said wrapper component is compliant with an existing multimedia application programming interface. In another example, the existing multimedia application programming interface is the OpenMAX IL API.

A second example of the invention provides an apparatus, comprising:

a processor

memory including computer program code

the memory and computer program code configured in use to, with the processor, cause the apparatus to perform at least the following:

perform a multimedia function in a computing device using a software wrapper component, said wrapper component comprising one or more multimedia software subcomponents each of which performs at least part of the multimedia function, said wrapper component being capable in use of controlling the one or more multimedia subcomponents to perform the multimedia function in response to a request from a client component.

A third example of the invention provides a computer program, comprising:

code for performing a multimedia function in a computing device using a software wrapper component, said wrapper component comprising one or more multimedia software subcomponents each of which performs at least part of the multimedia function, said wrapper component being capable in use of controlling the one or more multimedia subcomponents to perform the multimedia function in response to a request from a client component.

In an example, the computer program is a computer program product comprising a computer-readable medium bearing a computer program code embodied therein for use with a computer.

A fourth example of the invention provides a computer-readable medium encoded with instructions that, when executed by a computer, perform a multimedia function in a computing device using a software wrapper component, said wrapper component comprising one or more multimedia software subcomponents each of which performs at least part of the multimedia function, said wrapper component being capable in use of controlling the one or more multimedia subcomponents to perform the multimedia function in response to a request from a client component.

A fifth example of the invention provides an apparatus, comprising means for performing a multimedia function in a computing device, said means comprising one or more multimedia software subcomponents each of which performs at least part of the multimedia function, said means being capable in use of controlling the one or more multimedia subcomponents to perform the multimedia function in response to a request from a client component.

### BRIEF DESCRIPTION OF THE DRAWINGS

Embodiments are hereinafter described with reference to the accompanying diagrams where:

FIG. 1 is a schematic diagram of an OpenMAX IL environment;

FIG. 2 is a schematic representation of a computing device in which an embodiment of the invention is implemented;

FIG. 3 is a schematic diagram illustrating the arrangement of hardware components of the computing device of FIG. 2;

FIG. 4 is a schematic diagram illustrating the arrangement of hardware and software components of the computing device of FIG. 2 when arranged according to an embodiment of the invention;

FIG. 5 is a functional diagram of a multimedia use case running on the computing device of FIG. 2 and incorporating a first embodiment of the invention;

FIG. 6 is a flow diagram illustrating the operation of the use case of FIG. 5;

FIG. 7 is a functional diagram of a multimedia use case running on the computing device of FIG. 2 and incorporating a second embodiment of the invention;

FIG. 8 is a flow diagram illustrating the operation of the use case of FIG. 7; and,

FIG. 9 is a function diagram of a multimedia use case running on the computing device of FIG. 2 and incorporating a third embodiment of the invention.

### DESCRIPTION OF EMBODIMENTS

OpenMAX is a standard developed by The Khronos Group. OpenMAX provides a set of APIs for developing components and applications which are portable across multiple different computing environments. OpenMAX provides three layers of interfaces: Application Layer (AL), Integration Layer (IL) and Development Layer (DL).

OpenMAX IL provides an API and is an existing multimedia application programming interface. In particular, OpenMAX IL provides an API for interfacing between media frameworks or applications and a set of components, each of which provide at least part of a multimedia function for the framework or application. For example, for a media player software application to play an MP3 file to a human user the media player requires use of an MP3 file, a file decoder and a speaker. OpenMAX IL provides a means of interfacing between the media application, the file, the decoder and the speaker so that the media application can play the MP3 file on the speaker.

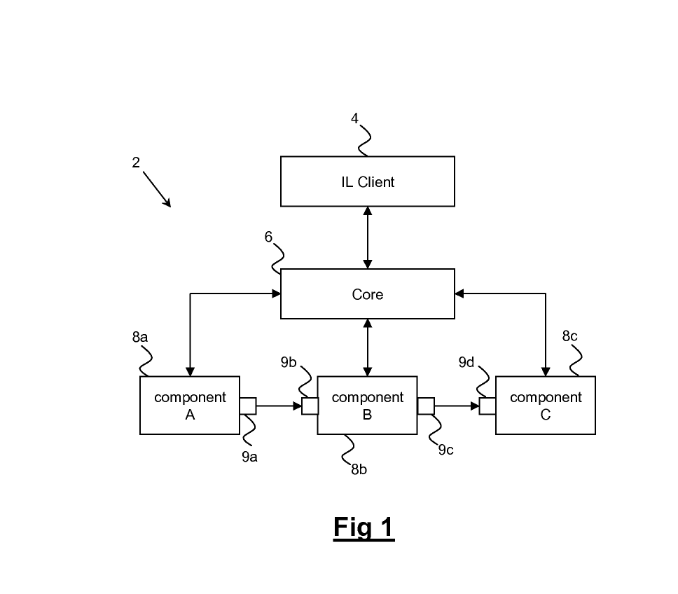

FIG. 1 provides a schematic representation of an OpenMAX IL environment 2. The OpenMAX IL API interfaces with a higher-level entity denoted as the IL client 4. The IL client 4 can be a filter graph multimedia framework (e.g. GStreamer), the OpenMAX AL API, or a software application or framework. In practice, the IL client 4 refers to any software that invokes a method (i.e. a function) of the OpenMAX IL environment (see below).

The OpenMAX IL API comprises two parts, a core API 6 and a component API (8a to 8c).

The core 6 is used for dynamically loading and unloading multimedia software components (8a to 8c) into main memory and for facilitating component (8a to 8c) communication. Once a component is loaded, the core 6 allows the IL client 4 to communicate directly with the component (8a to 8c). However, as the IL client 4 can only communicate with a component (8a to 8c) via the core 6, the IL client 4 calls a macro of the core 6 which causes the core 6 to call a method of a component (8a to 8c). Similarly, the core 6 allows the IL client 4 to establish a communication link (also known as a tunnel) between two components (8a to 8c). Once the tunnel is established, the core 6 is no longer used and communications flow directly between components (8a to 8c). Tunneled communication is shown on FIG. 1 between components A and B, and components B and C.

The component API is used for creating new components (8a to 8c). Components (8a to 8c) represent individual modules of functionality. Components (8a to 8c) operate on four types of data: audio, video, image and other (e.g. time data for synchronisation). Components (8a to 8c) can have a function of a source, sink, codec, filter, splitter, mixer, or any other data operator. Depending on the implementation of a component, the component could represent a piece of hardware, a software codec, another processor, or a combination thereof.

Data communication to and from a component is conducted through interfaces called ports (9a to 9d). There are four types of ports defined in the OpenMAX IL and they correspond to the types of data a port may transfer, i.e. there are audio, video, and image data ports and other ports. A component can receive data through input ports (9b and 9d) or send data through output ports (9a and 9c). Similarly, a communication tunnel between two components can be established by connecting the output port of one component to an input port of another component (e.g. as shown between component A and B, and B and C). A port can represent a component's connection to a data stream via a buffer, i.e. a port can incorporate a buffer.

An OpenMAX IL component (8a to 8c) provides the IL client 4 with access to a standard set of component functions or methods. These functions allow the IL client 4 to get and set component and port configuration parameters, obtain and set the execution state of the component, send commands to the component, receive event notifications, allocate buffers, establish communications with a single component port, and establish communication between two component ports. Component parameters include data relevant to the component's operation (i.e. its particular function, e.g. a codec) or the actual execution state of the component (i.e. idle or executing). Buffer status, errors, and other time-sensitive data are relayed to the IL client 4 via a set of callback functions.

Considering the above, in an example, the IL client 4 may be a media player application running on a computing device. To provide MP3 playback functionality, the media player application communicates with the core 6 and instructs it to load component A (8a), component B (8b) and component C (8c). Component A represents an MP3 file and therefore provides a multimedia data source and has a single output port (9a). Component B represents an MP3 decoder and therefore must have an input port (9b) for receiving MP3 data and an output port (9c) for providing decoded samples. The decoder decodes the file data and converts it into Pulse Code Modulation (PCM) samples which it then passes to component C. Component C represents a sound-driver and therefore provides a sink and has a single input port (9d). The sound-driver sends the PCM sound samples to the computing device's speakers to initiate audio playback.

A description of a number of embodiments follows, provided by way of example only.

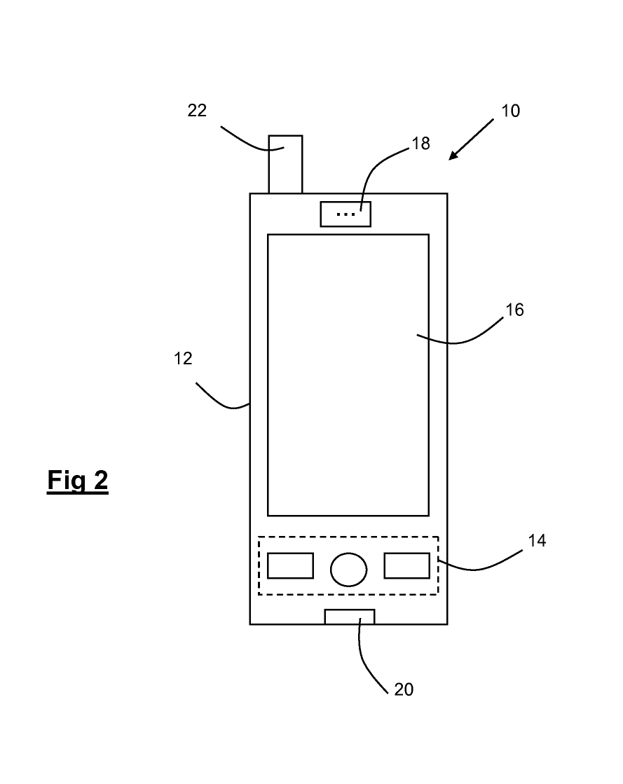

FIG. 2 is a schematic diagram of a computing device 10 having a casing 12. The computing device 10 forms the basis of the embodiments to be described. The casing 12 of the device 10 encapsulates a keypad 14, a touch-screen display 16, a speaker 18 and a microphone 20. The device 10 further includes an antenna 22. The device 10 illustrated in FIG. 2 is a mobile device in that it may be held in a user's hand and used to participate in communication sessions, in particular, telephone calls. During such sessions the device 10 may be utilised so that the speaker 18 is held to a user's ear and the microphone 20 is situated in proximity to a user's mouth.

The device 10 is a computing device which operates as a mobile phone. However, further embodiments relate to other computing devices which do not include telephony as their major function.

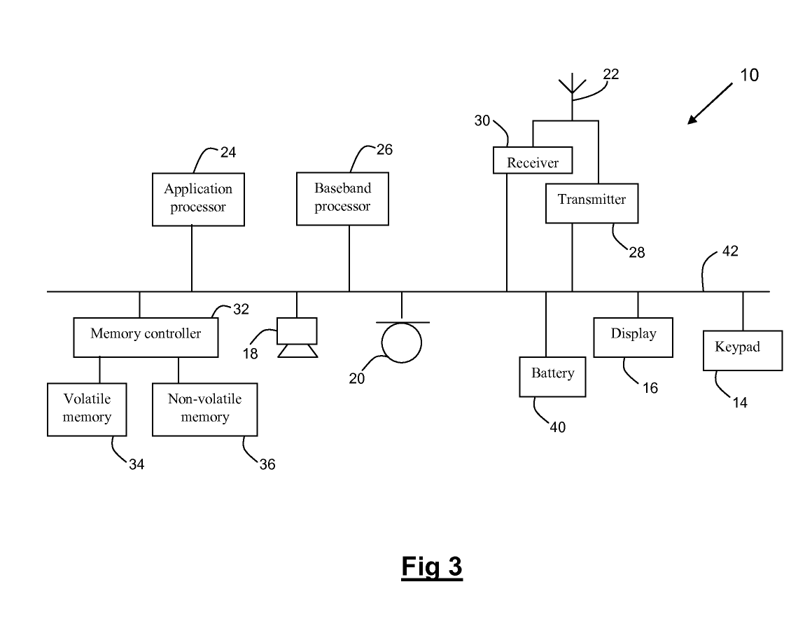

FIG. 3 is a schematic illustration showing the arrangement of the hardware components of the device 10 of FIG. 2. The keypad 14, display 16, speaker 18 and microphone 20 shown in FIG. 2 communicate with a system bus 42. The bus 42 further communicates with an application processor 24, a baseband processor 26, a transmitter 28, a receiver 30 and a battery 40. Transmitter 28 and receiver 30 communicate with the antenna 22. The bus 42 further communicates with a memory controller 32 which, in turn, communicates with volatile memory 34 and non-volatile memory 36. The application processor 24 processes instructions related to various software modules and operating system software which run on the device 10 and which provide various functionality of the device 10. The baseband processor 26 is concerned with the communication functions and to this end controls a telephony stack and communicates with the transmitter 28 and receiver 30 to establish communications by means of the antenna 22. The various processing elements of the device 10 such as the application processor 24 and baseband processor 26 may be provided on a single processor.

Memory controller 32 controls the access to, and interaction with, volatile memory 34 and non-volatile memory 36. In this manner the application processor 24 is able to communicate with the various hardware elements as well as the memory controller 32 and thereby control the operation of the various hardware elements according to software instructions stored on volatile memory 34 or non-volatile memory 36.

Only a single bus, bus 42, is illustrated in FIG. 3. It is to be realised that this bus may be replaced by two or more buses and that the topology of FIG. 3 would vary accordingly. Furthermore, known computing devices include hardware components additional to those illustrated in FIG. 3, but these are well known in the art and are not further described herein.

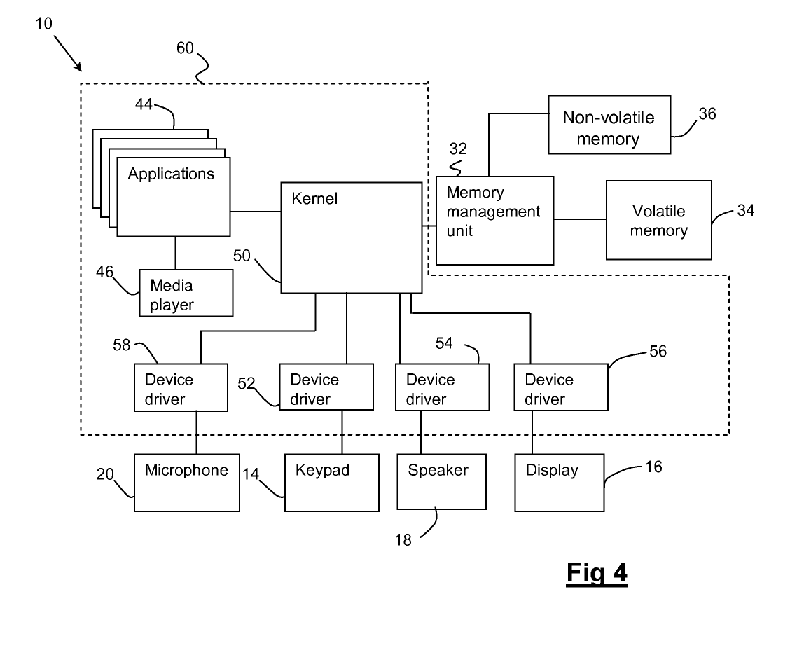

FIG. 4 is a diagram illustrating various hardware and software components of the device 10. The software operating on the device 10 can be categorised in various ways. Certain software operates to manage the resources provided by the various hardware components and to establish an operational environment in which other software executes. This software is known as the operating system of the device and is represented in FIG. 4 by a kernel 50. The kernel 50 interacts with the memory management unit 32 which, as previously described, communicates with volatile memory 34 and non-volatile memory 36. The kernel 50 further communicates with a plurality of applications 44 each of which may access the hardware components in a manner dictated by the kernel 50. The applications 44 are user applications, which may be started and terminated by the user. FIG. 4 shows that the applications 44 comprise a media player application 46. The media player 46 provides a means for a user of the device 10 to instruct the device 10 to exercise a particular multimedia use case including, but limited to, playing audio or video, recording audio or video, and viewing or editing an image.

The kernel 50 communicates with the keypad 14 by means of device driver 52, with speaker 18 by means of device driver 54 and with the display 16 by means of device driver 56. Only some of the hardware components have been illustrated but, generally, the kernel 50 controls the hardware resources of the device 10 through various device drivers. Furthermore, although the device drivers have been illustrated as separate to the kernel 50, it is possible for them to be incorporated into the kernel 50.

The software components of FIG. 4 are delineated by dashed area 60. However, this distinction between software and hardware is not essential. Components depicted as software in FIG. 4 may be rendered in hardware, and those depicted as hardware may, in certain circumstances, be rendered as software.

During operation of the device, software instructions stored in non-volatile memory 36 establish the kernel 50, the applications 44 and the device drivers 52, 54 and 56. Through the use of the various components illustrated in FIG. 3 a user is able to utilise the device 10 according to the functionality provided by the various applications 44. For example, a user uses the keypad 14 and/or the touch-screen display 16 to communicate with the kernel 50 by means of device drivers 52 and 56 to cause one of the applications 44 to access data stored on non-volatile memory 36 by means of memory management unit 32. The kernel 50 causes the data supplied by memory management unit 32 to be processed by the applications 44, typically running on the application processor 24. The application processor 24 will return results from the data and instructions, generally utilising volatile memory 34 in the process. On further instructions from the application, the kernel 50 will cause the results to be displayed to the user on display 16 by means of device driver 56. It is to be realised that device drivers 52, 54 and 56 are also software components originating from instructions stored on non-volatile memory 36.

The illustration of FIG. 4 is presented merely by way of example; known devices may comprise more components than those shown. Implementations of embodiments are not dependent on the precise arrangement and configuration of components shown in FIGS. 2, 3 and 4. Therefore other components with similar functionality may be substituted and further components added thereto, or illustrated components omitted therefrom, without affecting the operation of embodiments.

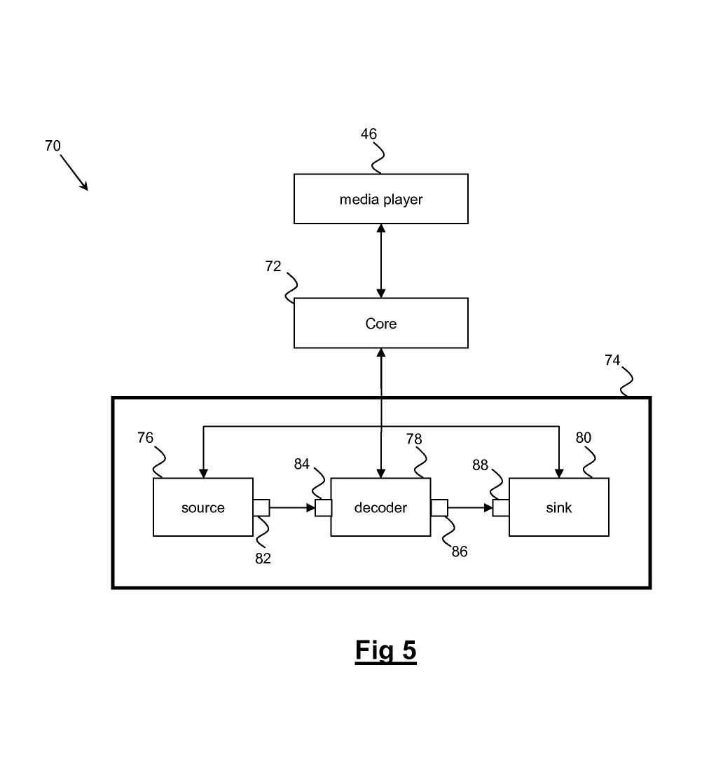

FIG. 5 illustrates an OpenMAX IL API environment present on the device 10. The environment of FIG. 5 represents a multimedia use case 70 and, in particular, the use case of playing an MP3 file. In the present example, the MP3 file is stored on the volatile memory 34 and is to be played on the speaker 18.

The media player application 46 acts as an IL client within the environment of FIG. 5. It is to be understood that the IL client is a client component within the context of this example. The media player 46 is in communication with a core 72. The core 72 is in communication with a wrapper software component 74 (hereinafter ‘wrapper’), comprising three multimedia software subcomponents, a source 76, a decoder 78 and a sink 80. Furthermore, in order to facilitate communication between the subcomponents 76 to 80, the source 76 comprises a output port 82, the decoder 78 comprises an input port 84 and an output port 86, and the sink 80 comprises an input port 88. The arrangement of ports 82 to 88 is such that tunneled communication is established between the source 76 and the decoder 78, and the decoder 78 and the sink 80. The media player 46 uses the core 72 to load the wrapper 74 including the individual multimedia subcomponents (76 to 80) of the wrapper 74 into the volatile memory 34 of the device 10 to enable the functionality of each element. Furthermore, the media player 46 uses the core 72 to establish the communication links between components 76 to 80.

The term ‘wrapper’ is used herein to describe a software entity which contains one or a number of software subcomponents. The wrapper functions to coordinate the subcomponents to provide the functionality of the subcomponents to a client component, such as, an IL client. In some examples of the invention, the wrapper additionally provides management functionality to assist in coordinating the subcomponents.

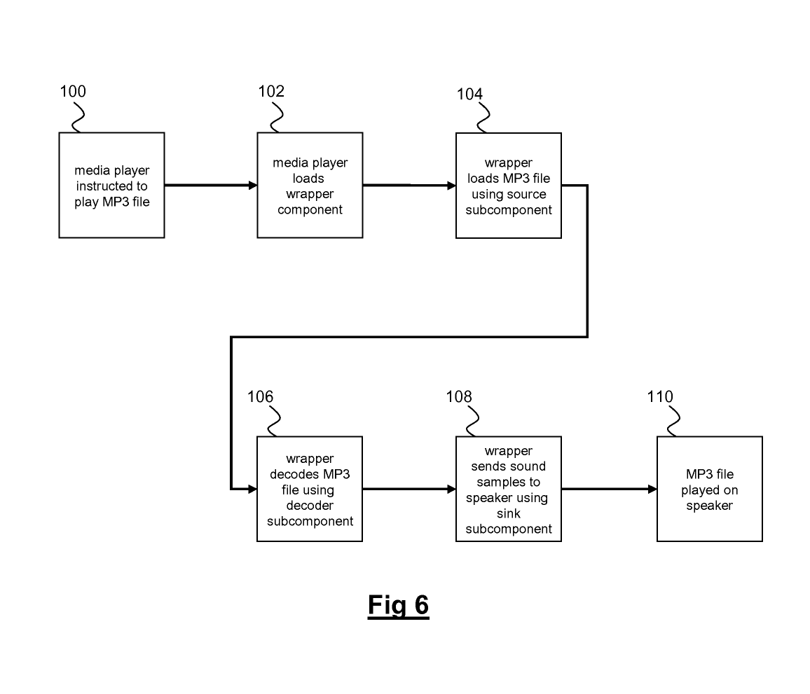

In operation the wrapper 74 is capable of performing a complete multimedia function, which in the present example comprises playing an MP3 file. Accordingly, the wrapper 74 provides a means for performing a complete multimedia function. The operation of the wrapper 74 to play an MP3 file is now described with reference to the flow diagram of FIG. 6.

Processing in FIG. 6 begins at step 100, wherein the media player 46 is instructed to play an MP3 file. The media player 46 may be instructed by another of the applications 44 or by an operating system of the device 10. It is also possible that a user of the device 10 may instruct the media player 46 to play an MP3 file via, for example, an input provided to the touch-screen display 16 or the keypad 14. It is further possible that any instruction sent to the media player 46 is sent via the kernel 50. In any case, processing flows from step 100 to step 102 once the media player 46 has received an instruction to play a specific MP3 file stored on the non-volatile memory 36.

At step 102, the media player 46 loads the wrapper 74 into main memory. In the present example, the wrapper 74 is loaded into volatile memory 34. Further, in this case the wrapper relates specifically to the desired use case, i.e. ‘play an MP3 file’. Loading of the wrapper 74 is performed by the media player 46 and the core 72. In particular, the media player 46 instructs the core 72 to load each of the multimedia subcomponents 76 to 80 of the wrapper component 74 into the volatile memory 34. The media player 46 also instructs the core 72 to configure the wrapper 74 by automatically establishing appropriate communication links between components 76 to 80. In the present example, the core 72 establishes a tunneled communication link between the source 76 and the decoder 78, and the decoder 78 and the sink 80. Processing flows from step 102 to 104 once the wrapper 74 has been loaded into memory and configured. Once the wrapper 74 has been loaded and configured the media player 46 can delegate the job of driving the use case (i.e. playing an MP3 file) to the wrapper 74.

At step 104, the wrapper 74 uses the source 76 to load the MP3 file corresponding to the one specified in the original instruction received by the media player 46 at step 100. As such, the source subcomponent 76 represents a software file loader. Once the specified file has been loaded the MP3 data contained within is passed by the source 76 to the decoder 78, following which processing flows to step 106.

At step 106, the wrapper 74 uses the decoder 78 to decode the MP3 data from the source 76 to generate pulse code modulation (PCM) sound samples. The decoder 78 could represent a software decoder which uses the application processor 24 to implement the decoding algorithm. Alternatively, the device 10 could comprise a hardware accelerator and the decoder 78 could represent a software decoder which uses the accelerator to implement the decoding algorithm. In any case, the decoded PCM samples are sent from the decoder 78 to the sink 80 and processing flows to step 108.

At step 108, the sink 80 receives the PCM samples and sends them to the speaker 18. The sink represents the device driver 54 and as such controls the speaker 18 to play the decoded PCM samples. Step 110 represents the final step, wherein the speaker 18 plays the PCM samples.

The behaviour of OpenMAX IL multimedia subcomponents (76 to 80) can be modeled by a finite state machine. Accordingly, the methods of each subcomponent can be called to drive the subcomponent's behaviour as defined by the finite state machine and thereby activate the functions of the subcomponent. The behaviour of a wrapper component as a whole can also be modeled by a finite state machine. The IL client (i.e. the media player 46) can request state changes on the wrapper to drive the specialised use case of the wrapper. Stated differently, the IL client can simply drive the wrapper and the wrapper will then drive its individual subcomponents so that the wrapper behaves according to its finite state machine.

The wrapper 74 provides a grouping together of various OpenMAX IL components (i.e. multimedia subcomponents 76 to 80) under a single monolithic OpenMAX IL component (i.e. wrapper component 74). Further, the wrapper groups a set of associated multimedia subcomponents which form a functional group capable of exercising a specialised multimedia use case, i.e. playing an MP3 file. Other use cases are of course possible, such as, playing a WMA file, steaming a video file, recording a video file, capturing a JPEG image and displaying a JPEG image. In other examples, individual wrapper components for each use case can be provided. Each wrapper will contain the subcomponents necessary to provide the use case to which it is associated (e.g. playing a WMA file, steaming a video file, recording a video file, capturing a JPEG image and displaying a JPEG image). In general, the wrapper receives commands from an IL client (i.e. the media player 46) that trigger the wrapper's particular use case. Internally, the wrapper calls the required commands on its subcomponents (i.e. the multimedia subcomponents 76 to 80) and the wrapper is able to deal with the events issued by the subcomponents. The wrapper also sends callbacks to the IL client (i.e. the media player 46) when required, in order to conform with the OpenMAX IL API.

The wrapper 74 is capable of resource management. Resource management relates to controlling the access of components (76 to 80) to a limited resource, for example, a hardware resource such as memory 34 or battery 40. The wrapper 74 is therefore aware of how much of a specific resource is available, which components are currently using the resource, and how much of the resource the components are using. The wrapper 74, as resource manager, will recommend to a policy manager which components should be pre-empted or resumed based on resource conflicts and availability. In the present example, decoding MP3 data generates data in the form of sound samples which must be stored in the volatile memory 34 so that they can be subsequently played on the speaker 18. The volatile memory 34 has a finite storage capacity which must also be available to elements of the device 10 besides components 76 to 80. Accordingly, the wrapper 74 is aware of the capacity of volatile memory 34 and manages access to it so that the device 10 can function.

The wrapper 74 is capable of policy management. The policy manager is responsible for managing subcomponent chains or streams, wherein a subcomponent steam is a collection of components which collaborate to perform a multimedia function. In the preset example, the components 76 to 80 provide a subcomponent stream, wherein the steam performs the multimedia function of playing an MP3 file. Policy management is used to determine if a stream can run based on information including resources, system configuration, and other factors. Therefore, the wrapper controls the operation of components 76 to 80 to play an MP3 file in dependence on this information.

The operation of the wrapper 74 is such that multimedia subcomponents can be dynamically inserted or removed once the wrapper 74 has been loaded into memory and its associated multimedia function started. For example, the wrapper 74 could be arranged so that the decoder subcomponent 78 is not loaded at step 102 when the other parts of the wrapper 74 are loaded. Instead, the particular decoder subcomponent loaded could depend on the file format of the file loaded by the source 76. If an MP3 file is loaded at step 104, then an MP3 decoder subcomponent could be loaded at step 106 before the file is decoded. Alternatively, if a WMA (windows®) media audio) file is loaded at step 104, then a WMA decoder subcomponent could be loaded at step 106 before the file is decoded. Alternatively, an MP3 decoder could be loaded at step 102 and then if a WMA file is loaded at step 104 the MP3 decoder could be removed and a WMA decoder inserted in its place at step 106 before the WMA file is decoded.

The operation of the wrapper 74 is such that the media player 46 can load the wrapper 74 and then delegate the job of playing an MP3 file to it. Stated differently, the media player 46 does not need to concern itself with the individual steps which combine to play an MP3 file, such as, loading an MP3 file, decoding the file or sending the decoded file to a device driver. That said, the media player 46 can still access the individual functions of each multimedia subcomponent 76 to 80 if required. Furthermore, any input to or output from a wrapper 74 can be accessed by other OpenMAX components or IL clients. In particular, an input port of a wrapper is provided by an input of the first subcomponent in the wrapper's subcomponent stream whereas an output port of a wrapper is provided by an output of the last subcomponent in the wrapper's subcomponent stream. Such ports are referred to as ‘edge’ ports as each is located at an edge of the subcomponent stream, i.e. at an inlet or an outlet of the steam. It is noted that in the example of FIG. 5 the first subcomponent is source 76 which does not have an input port, and the last subcomponent is sink 80 which does not have an output port. However, in some embodiments of the invention a wrapper input port or output port does not correspond with an edge port of the wrapper's subcomponents. Instead, an input port or an output port of the wrapper may be any input port or output port of a particular subcomponent. In some other embodiments, certain subcomponent input and output ports may be predefined as a wrapper input port or output port.

The wrapper component is also fully compliant with the OpenMAX IL API and specification. Accordingly, the wrapper component is portable across multiple different computing platforms, and in particular, mobile computing platforms. Furthermore, the wrapper allows creation of a filter graph using only OpenMAX IL constructs and therefore, does so in a manner which is compliant with the OpenMAX IL standard. In the present example, the filter graph is formed from the source 76, the decoder 78 and the sink 80 which provide the complete multimedia function of playing an MP3 file.

An advantage of the wrapper component according to the present example is that a software framework or application (i.e. an IL client) can group together multiple OpenMAX IL multimedia subcomponents into a wrapper to exercise a particular multimedia use case, such as playing an MP3 file. Then, the IL client can delegate the job of driving the use case to the wrapper. This is advantageous because the wrapper is compliant to the OpenMAX IL component API and can be controlled as if it was an elementary OpenMAX IL component. Further, the wrapper can hide much of the complexity required to coordinate the various multimedia subcomponents grouped within it from the IL client. This method allows for simpler IL client implementations while maintaining compatibility with the OpenMAX IL standard. In particular, the IL client does not need to consider resource or policy management and instead can rely on the wrapper component to handle it. Allowing for simpler IL client implementations means that it is easier for software developers to design such IL clients and therefore, the time taken designing such IL clients is reduced.

It is an advantage of the present embodiment that one or more wrapper components can be pre-set so that applications and frameworks (i.e. IL clients) can easily take advantage of their functionality. In particular, frequently used multimedia functions can be pre-set and be used as building blocks from which to exercise particular use cases. For example, playing an MP3 file is a multimedia function which may be offered by a number of different applications or frameworks and as such, the wrapper 72 may be a pre-set wrapper. Additionally or alternatively, a group of other wrapper components may be pre-set to provide multimedia functions which include but are not limited to, playing a WMA file, steaming a video file, recording a video file, capturing a JPEG image and displaying a JPEG image. Accordingly, creating an IL client which can provide any of these multimedia functions is simplified, thereby reducing the time taken to develop such an IL client.

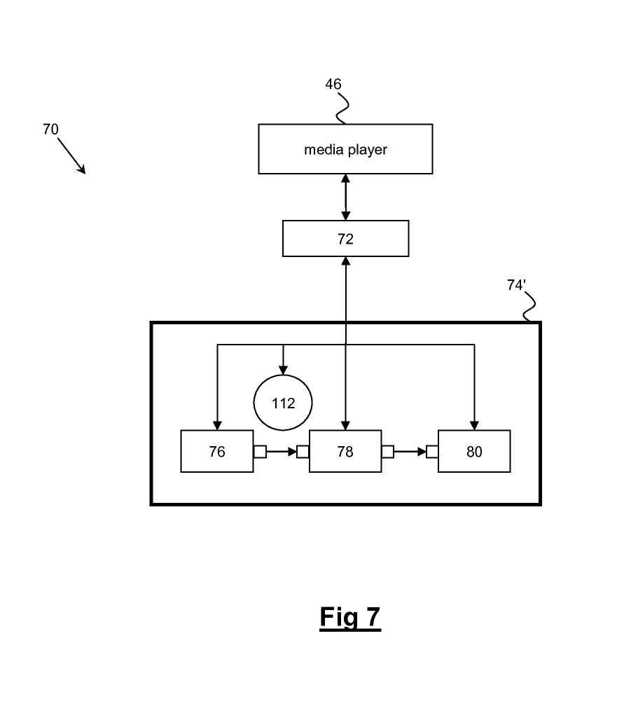

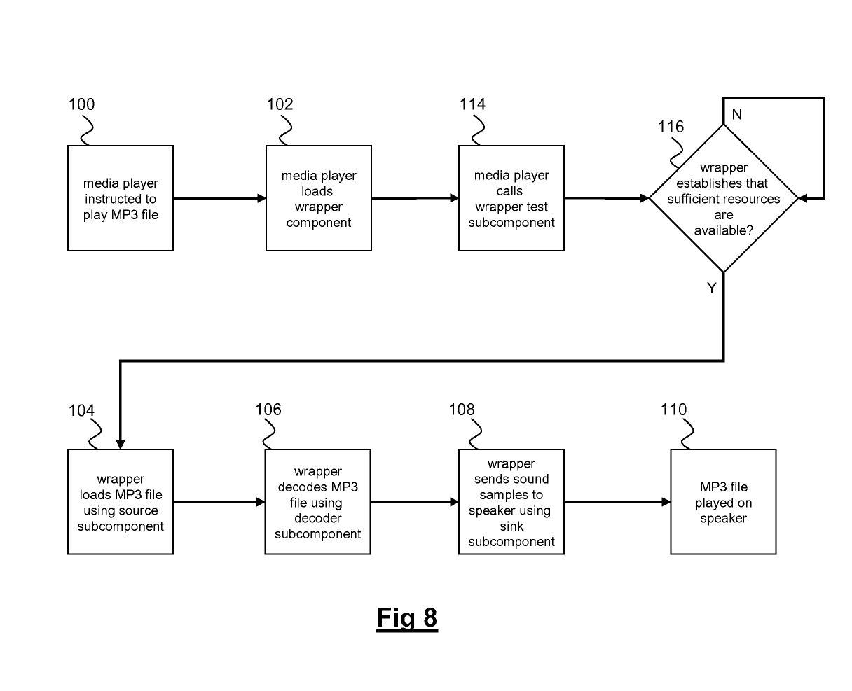

FIG. 7 is an OpenMAX IL environment illustrating a second embodiment of the invention. The OpenMAX IL environment of FIG. 7 is identical to the environment of FIG. 5 with the following exception. The wrapper (renumbered in FIG. 8 as 74′) additionally comprises a test component 112. Once the wrapper component 74′ has been loaded, the media player 46 (acting as the IL client) can call the test component 112. Calling the test component 112 requests the wrapper 74′ to notify the media player 46 if the device 10 has enough available resources to perform the multimedia function of the wrapper 74′, i.e. playing an MP3 file through speaker 18. For example, a resource may be a limited resource, such as, the volatile memory 34 or the battery 40.

In order to provide the above functionality, the wrapper component 74′ is capable of identifying which resources of the device 10 will be required to perform its multimedia function. Further, the wrapper component 74′ is capable of establishing how much of each identified resource it requires and how much of each identified resource there is available. In some embodiments it is the resource management and/or policy management functionality of the wrapper component which provides this capability. In the event the wrapper 74′ establishes that there is not enough of at least one identified limited resource available, the wrapper 74′ does not respond to the media player's call. However, in the event that there are enough identified limited resources available the wrapper 74′ responds to the media player's call. In the event that the media player 46 receives a response from the wrapper 74′, the media player 46 instructs the wrapper 74′ to exercise its multimedia function.

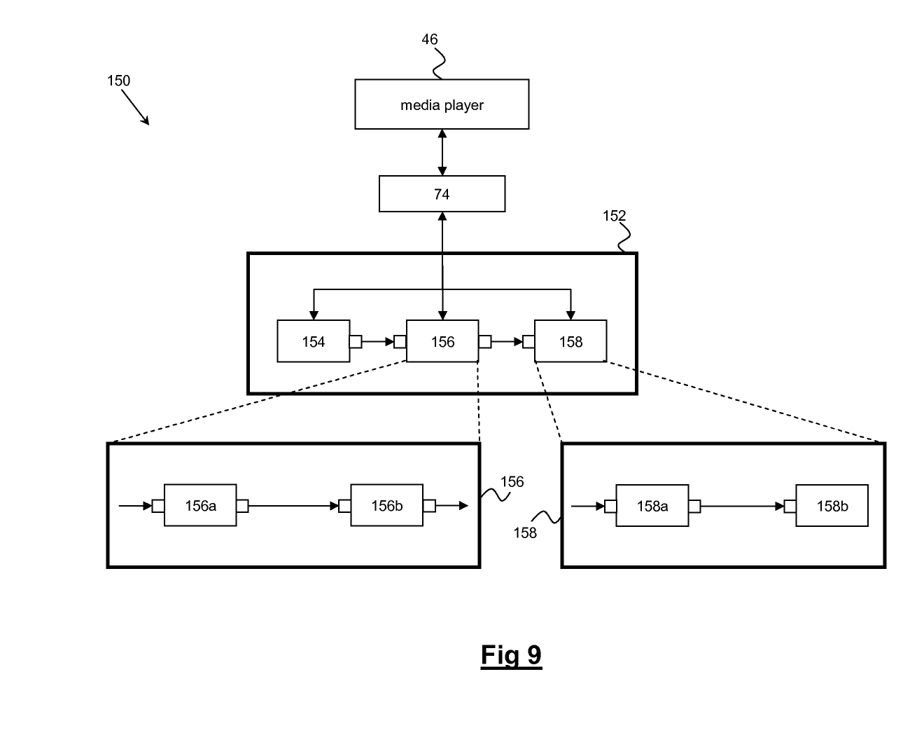

The above-described operation is now explained with reference to the flow diagram of FIG. 8. It is noted that the operation of wrapper 74′ is similar to the operation of the wrapper 74 discussed above with reference to FIG. 6. The following describes the differences between the operation according to FIG. 6 and the operation according to FIG. 9.

Processing flows from step 102 to step 114 once the wrapper 74′ has been loaded into memory and configured. At step 114, the media player 46 calls the test component 112, following which processing flows to step 116. At step 116, the wrapper component 74′ identifies which limited resources of the device 10 are required in order to perform its multimedia function of playing an MP3 file. Then, the wrapper component 74′ establishes if there is a sufficient amount of each identified resource available. In the event that there is not enough of at least one of the identified device resources, processing waits at step 116 until sufficient resource is available. Alternatively, in the event that there is enough of all the identified device resources, processing flows to step 104. Processing from step 104 is as discussed above with reference to FIG. 6.

It is to be understood that in other embodiments of the invention rather than processing waiting at step 116 until sufficient device resources are available, the wrapper 74′ could additionally or alternatively, notify the media player 46 that insufficient resources are available and that the multimedia function (i.e. playing an MP3 file) cannot be performed. In this case, the media player 46 may then display an appropriate message on the display 16 to relay this message to the user.

The first and second embodiments described herein have been discussed with reference to the use case of playing an MP3 file. Furthermore, those embodiments considered wrapper components which include three components. It is to be understood that embodiments of the invention would be equally as effective when used to exercise other multimedia use cases. Additionally, it is to be understood that embodiments would be equally as effective when used in connection with a different number of components. For example, more or less than three components could be used to exercise a particular multimedia use case. Additionally, different types of subcomponent could be created. For example, rather than a decoder subcomponent, a renderer subcomponent could be used instead. It is to be noted that changing the functionality of the components will in turn change the use case enacted by the wrapper component and the OpenMAX IL environment created. In particular, components could be used having the functionality of a source, a sink, a codec, a filter, a splitter, a mixer, or any other data operator. Furthermore, such components could be used to realise any multimedia use case, including but not limited to, playing a video file on a display screen, recording a video using a camera, displaying an image on a display screen, capturing an image in a file.

FIG. 9 is an OpenMAX IL environment illustrating a third embodiment of the invention. The OpenMAX IL environment of FIG. 9 illustrates a multimedia use case 150, including three wrapper components, 152, 156 and 158. More specifically, the wrapper component 152 comprises a multimedia subcomponent 154 having one output, the wrapper component 156 having one input and one output, and the wrapper component 158 having one input. The wrapper components 156 and 158 are nested within the wrapper component 152.

The wrapper component 156 comprises a multimedia subcomponent 156a having an input and an output, and a multimedia subcomponent 156b having an input and an output. The wrapper component 158 comprises a multimedia subcomponent 158a having an input and an output, and a multimedia subcomponent 158b having an input.

The operation of the use case 150 of FIG. 9 is as described with reference to FIG. 6. However, in step 102 the three wrapper components 152, 156 and 158 are loaded by the media player 46 using the core 74.

An advantage of nesting one wrapper component within another is that the functionality of the nested wrapper is available to the wrapper within which it is nested. As mentioned above with reference to the first embodiment, a number of wrapper components can be pre-set to provide a number of building blocks of multimedia functionality. In such circumstances, it is useful to be able to nest one functionality inside another to construct a single wrapper component which can perform the complete multimedia functions of a number of building blocks. For example, a first wrapper component may be pre-set to provide the function of playing an MP3 file on a speaker. Also, a second wrapper component may be pre-set to take an MP3 file and perform some complex data processing on its content, for example, to improve the audibility of the sound data in the file. As wrapper components may be nested inside other wrapper components, it is possible to nest the second wrapper component inside the first wrapper component, so that the MP3 file is processed before it is played on the speaker.

It is to be understood that a wrapper component having no input or output ports (i.e. wrapper components 74, 74′ and 152) is called herein a stream wrapper component. Also, a wrapper component having one input port and one output port (i.e. wrapper component 156) is called herein a filter wrapper component. Further, a wrapper component having one input port (i.e. wrapper component 158) is called herein a sink wrapper.

It is to be understood that wrapper components according to some embodiments of the invention are created using the following two constructs, the ‘Composite pattern’ and the ‘OpenMAX IL Component extension mechanism’. In particular, wrapper component composition is achieved using the OpenMAX IL Component Extension API to create a new Index and Config structure pair, such as, for example, OMX_IndexConfigWrapperCompList, and OMX_CONFIG_MG_COMPONENTLIST_TYPE. In this case, the component list type structure contains a list of OpenMAX IL component names (or even component roles, depending on different implementations) to be added as the subcomponents of the wrapper component. Furthermore, in embodiments where the IL client requires access to the individual subcomponents of the wrapper, the IL client can acquire the subcomponent's handles using the extension mechanism and thereby access the subcomponent's functions. For example, a new Index and Config structure pair extension could be used, such as, OMX_IndexConifgWrapperComponentHandIes, and OMX_CONFIG_MG_COMPONENTHANDLESTYPE.

In the embodiments discussed above, the media player application has acted as a client component by assuming the role of an IL client. However, it is to be understood that the media player application merely provides an exemplary IL client. Moreover, other applications would provide equally suitable IL clients. For example, other suitable IL clients could be other software applications, such as, an email application or a calendar application. Also, the role of the IL client may be provided by a framework, such as, the OpenMAX AL API. Further, the role of the IL client may be provided by any software of the computing device which is capable of calling a function or method of the OpenMAX IL environment, such as, a function of a multimedia subcomponent of a wrapper.

It is to be understood that a wrapper component according to some embodiments of the invention could be used on a computing device platform other than a mobile phone. For example, the wrapper could be used with a personal digital assistant, a laptop computer, a desktop computer, a portable MP3 player or a portable MP4 player.

The above examples and embodiments of the invention have related to the OpenMAX IL API and standard. However, it is within the scope of the appended claims that some embodiments of the invention relate to other existing multimedia application programming interfaces.

Finally, various additions and modifications may be made to the above described embodiments to provide further embodiments, apparent to the intended reader being a person skilled in the art, any and all of which are intended to fall within the scope of the appended claims.

1.-15. (canceled)

16. A method comprising:
performing a multimedia function in a computing device using a software wrapper component, the wrapper component comprising one or more multimedia software subcomponents each performing at least part of the multimedia function, the wrapper component being configured to of control the one or more multimedia subcomponents to perform the multimedia function in response to a request from a client component.

17. The method according to claim 16 further comprising at least one of inserting into or removing from the wrapper component at least one of the one or more multimedia subcomponents while performing the multimedia function.

18. The method according to claim 16 further comprising providing an output to the client component, the output comprising a callback from at least one of the one or more multimedia subcomponents.

19. The method according to claim 16 further comprising providing the client component with access to control a function of at least one of the one or more multimedia subcomponents.

20. The method according to claim 16 further comprising managing access to a limited resource of the computing device by at least one of the one or more multimedia subcomponents.

21. The method according to claim 16 further comprising:
receiving from the client component an instruction to be notified if there are sufficient computing device resources available for the wrapper component to control the one or more multimedia subcomponents to perform the multimedia function;
identifying if sufficient computing device resources are currently available; and
notifying the client component if sufficient computing device resources are currently available.

22. An apparatus comprising:
at least one processor; and
at least one memory including computer program code the at least one memory and the computer program code configured in use to, with the at least one processor, cause the apparatus to perform at least the following:
perform a multimedia function in the apparatus using a software wrapper component, the wrapper component comprising one or more multimedia software subcomponents each performing at least part of the multimedia function, the wrapper component being configured to control the one or more multimedia subcomponents to perform the multimedia function in response to a request from a client component.

23. The apparatus according to claim 22, wherein the apparatus is further caused to: at least one of insert into or remove from the wrapper component at least one of the one or more multimedia subcomponents while performing the multimedia function.

24. The apparatus according to claim 22, wherein the apparatus is further caused to: provide an output to the client component, the output comprising a callback from at least one of the one or more multimedia subcomponents.

25. The apparatus according to claim 22, wherein the apparatus is further caused to: provide the client component with access to control a function of at least one of the one or more multimedia subcomponents.

26. The apparatus according to claim 22, wherein the wrapper component further comprises: an input port corresponding to an input port of one of the one or more multimedia subcomponents; and an output port corresponding to an output port of one of the one or more multimedia subcomponents, wherein the input port and output port are configured to communicate with other wrapper components and the client component.

27. The apparatus according to claim 22, wherein the apparatus is further caused to: manage access to a limited resource of the computing device by at least one of the one or more multimedia subcomponents.

28. The apparatus according to claim 22, wherein the apparatus is further caused to:
receive from the client component an instruction to be notified if there are sufficient computing device resources available for the wrapper component to control the one or more multimedia subcomponents to perform the multimedia function;
identify if sufficient computing device resources are currently available; and
notify the client component if sufficient computing device resources are currently available.

29. The apparatus according to claim 22, wherein the wrapper component is compliant with an existing multimedia application programming interface.

30. The apparatus according to claim 29, wherein the existing multimedia application programming interface is an OpenMAX IL API.

31. A computer program product comprising at least one computer readable medium having program code stored thereon, the program code which when executed by an apparatus cause the apparatus at least to:
perform a multimedia function in a computing device using a software wrapper component, the wrapper component comprising one or more multimedia software subcomponents each performing at least part of the multimedia function, the wrapper component is configured to control the one or more multimedia subcomponents to perform the multimedia function in response to a request from a client component.

32. The computer program product according to claim 31, wherein the computer program code further causes the apparatus to: at least one of insert into or remove from the wrapper component at least one of the one or more multimedia subcomponents while performing the multimedia function.

33. The computer program product according to claim 31, wherein the computer program code further causes the apparatus to: provide an output to the client component, the output comprising a callback from at least one of the one or more multimedia subcomponents.

34. The computer program product according to claim 31, wherein the computer program code further causes the apparatus to: provide the client component with access to control a function of at least one of the one or more multimedia subcomponents.

35. The computer program product according to claim 31, wherein the computer program code
further causes the apparatus to:
receive from the client component an instruction to be notified if there are sufficient computing device resources available for the wrapper component to control the one or more multimedia subcomponents to perform the multimedia function;
identify if sufficient computing device resources are currently available; and
notify the client component if sufficient computing device resources are currently available.
